(19) United States
(12) Patent Application Publication
(10) Pub. No.: US 2025/0131752 A1
(43) Pub. Date: Apr. 24, 2025

(54) METHOD OF DETECTION OF PARTICLES PRESENT IN A LIQUID

(71) Applicant: Commissariat à l'Energie Atomique et aux Energies Alternatives, Paris (FR)

(72) Inventors: Xavier MERMET, Grenoble cedex 09 (FR); Tommy DEDOLE, Grenoble cedex 09 (FR); Caroline PAULUS, Grenoble cedex 09 (FR)

(73) Assignee: Commissariat à l'Energie Atomique et aux Energies Alternatives, Paris (FR)

(21) Appl. No.: 18/912,691

(22) Filed: Oct. 11, 2024

(30) Foreign Application Priority Data
Oct. 23, 2023 (FR) 2311476

(51) Int. Cl. G06V 20/69; G01N 15/075; G06T 7/20; G06T 7/70

(52) U.S. Cl. CPC G06V 20/698; G01N 15/075; G06T 7/20; G06T 7/70

(57) ABSTRACT

A method of detection of particles of a first type, called first particles (P1), present in a liquid (L), the liquid also containing particles of a second type distinct from the first type, and called second particles (P2), the liquid (L) being placed in a fluidic chamber, the first particles (P1) each having a density distinct from that of the liquid (L) and from that of each of the second particles (P2), the fluidic chamber having a closed volume occupied entirely by the liquid (L), the detection being achieved by capturing images of the fluidic chamber.

### TECHNICAL FIELD OF THE INVENTION

The present invention relates to a method for detecting particles present in a liquid.

### PRIOR ART

In certain applications, it proves useful to detect the presence of certain particles in a liquid, with a view potentially to classifying and counting them. This is for example the case when identifying problems with pollution, or monitoring the concentration of particles in the analysed liquid. The particles may be microplastic particles, air bubbles, metal particles, etc.

Patent EP33432011B1 describes a method for counting particles present in a fluid moving through a fluidic chamber. The particles are entrained by the movement of the fluid. Detection is achieved through lensless imaging, using a light source and an image sensor. The image sensor is controlled to acquire a plurality of successive images of the fluidic chamber. Processing means are employed to compute the path of the particles and to deduce therefrom the number of particles passing through the fluidic chamber.

The principle of this solution is based on a moving fluid, and is not applicable to an inert fluid. In addition, processing times may be long.

There is a need to provide a solution allowing particles present in a liquid to be detected, with a view potentially to being able to sort and/or count them, that is simple to implement and that does not require long processing times.

### DESCRIPTION OF THE INVENTION

This aim is achieved via a method of detection of particles of a first type, called first particles, present in a liquid, said liquid also containing particles of a second type distinct from the first type, and called second particles, said liquid being placed in a fluidic chamber, said first particles each having a density distinct from that of the liquid and from that of each of the second particles, said fluidic chamber having a closed volume occupied entirely by said liquid, said detection being achieved by capturing images of said fluidic chamber, said method consisting in:
capturing at a first time at least a first image of the fluidic chamber, said fluidic chamber being in a first position,
capturing at a second time, subsequent to the first time, at least a second image of the fluidic chamber in a second position, said second position being a position that is inclined with respect to a horizontal plane and that is configured to initiate at least one movement of the first particles inside the liquid,
processing said captured images to determine the movement and/or speed of the first particles present in the liquid,
discriminating between the first particles and second particles on the basis of the movement and/or speed of said first particles in the liquid, said movement and/or speed of said first particles and said second particles in the liquid depending on their respective density with respect to that of the liquid.

According to a first particular embodiment, the first position is a position in which the fluidic chamber is oriented parallel to said horizontal plane.

According to a second particular embodiment, the first position is a position that is inclined at a first angle of inclination with respect to said horizontal plane and the second position is a position making a second angle of inclination to the horizontal plane that is more pronounced than said first angle of inclination.

According to one particularity of the second embodiment, the first position and the second position are identical.

According to one particularity, the method comprises:
a step of determining the position of the first particles and of the second particles at the first time, and
a first step of estimating the position of the first particles and of the second particles at the second time and of determining, for each particle, a first estimated position zone at the second time.

According to another particularity, the method comprises:
a step of verifying at the second time the position of the first particles and of the second particles with respect to their first estimated position zone, and
a step of determining the path of each particle detected at the second time in its first estimated position zone.

According to another particularity, the method comprises a second step of estimating the position of the particles not detected in their first estimated position zone and of determining a second estimated position zone for these particles.

The invention also relates to a detection system, employed to implement the detection method such as defined above, the detection system comprising:
a fluidic chamber intended to be filled with the liquid containing the first particles and second particles,
a mechanical device that is able to be actuated to make the fluidic chamber or the entire device pivot to its second position,
an imaging device comprising at least one light source and an image sensor, said fluidic chamber being placed between said light source and the image sensor,
means for processing the images acquired by the sensor.

According to one particularity, the fluidic chamber is formed in a component having two parallel walls that are transparent to one or more wavelengths of the light emitted by the light source.

According to another particularity, the light source comprises one or more light-emitting diodes, or at least one laser diode.

### BRIEF DESCRIPTION OF THE FIGURES

Other features and advantages will become apparent in the following detailed description given with reference to the appended drawings, in which:

FIG. 1 schematically shows the system of the invention;

FIG. 2 shows a flowchart of the steps of the detection method of the invention;

FIGS. 3A to 3H illustrate the various steps of the detection method of the invention.

### DETAILED DESCRIPTION OF AT LEAST ONE EMBODIMENT

An orthonormal coordinate system X, Y, Z will be referred to in the remainder of the description. The two directions X and Y define a horizontal plane and the direction Z defines a vertical direction.

The invention relates to a method of detection of particles in a liquid L, implemented to discriminate between the particles, with a view to being able to count and/or sort them inside the liquid L.

The particles to be detected may be of any type. It may for example be a question of microplastic particles, of air bubbles or of metal particles. It may also be a question of dust particles, of cells, of micro-organisms or of microbeads, as commonly implemented in biological applications, or even of microalgae. It may also be a question of droplets that are insoluble in the liquid, for example oil droplets dispersed in an aqueous phase. The carrier medium is a liquid, for example water, oil or a biological liquid.

One of the aims of the invention is notably to make it possible to discriminate between particles of a first type, called first particles P1, and particles of a second type, called second particles P2. The first particles P1 and the second particles P2 notably differ from each other in their density.

Moreover, in the context of the invention, the first particles P1 will be considered to have a density distinct from that of the liquid L (for example higher than that of the liquid L).

Therefore, two cases may be distinguished:
a first case in which the second particles P2 each have a density distinct from (for example lower than) that of the first particles P1, but equivalent to that of the liquid L;
a second case in which the second particles P2 each have a density distinct from that of the first particles P1 and also distinct from that of the liquid L (for example lower than that of the liquid L).

The method is implemented using a detection system that mainly comprises:
a fluidic device comprising a fluidic chamber 10, the fluidic chamber 10 defining an internal volume intended to be entirely filled with the liquid L and the particles P1, P2 placed in the liquid;
an imaging device;
a mechanical device;
processing means.

### Fluidic Device

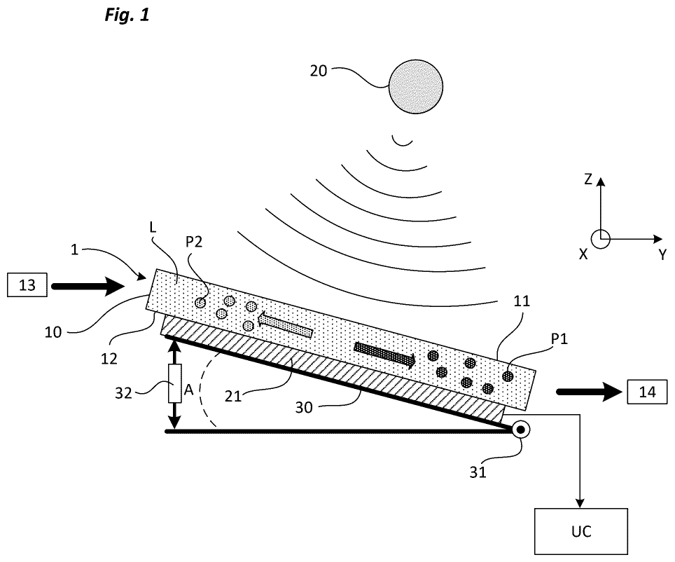

### FIG. 1

The fluidic chamber 10 may be formed in a component 1 having two parallel walls 11, 12 that are transparent to the emission wavelengths of the light source 20 of the imaging device. The component 1 may be a fluidic chip, or a microscope slide on which a frame intended to form the fluidic chamber is placed. It may also be a question of any type of container capable of receiving a fluid and possessing at least one optically transparent face (in the case of an imaging system operating in reflection) or two opposite transparent faces (in the case of an imaging system operating in transmission).

The fluidic device may comprise a fluidic inlet 13 that is intended to be connected to the fluidic chamber 10, with a view to injecting the liquid L into the fluidic chamber, and a fluidic outlet 14 that is also connected to the fluidic chamber 10, with a view to removing the liquid L from the fluidic chamber. Valves may be placed on the fluidic inlet and the fluidic outlet, and a pump (not shown) may be controlled to control injection of the liquid L into the fluidic chamber 10 via the fluidic inlet and removal of the liquid L from the fluidic chamber 10 via the fluidic outlet.

### Imaging Device

### FIG. 1

For the sake of simplicity, the imaging device is advantageously a lensless device. In this case, it comprises a light source 20 composed of one or more light-emitting diodes. It may be associated with a diffuser and with a pinhole, or with an optical fibre. The light source 20 may also be a laser diode.

Of course, a conventional microscopy setup could also be envisaged, instead of the lensless imaging setup.

The fluidic chamber 10 is placed between the light source 20 and an image sensor 21. The imaging device therefore operates in transmission.

The image sensor 21 employed is capable of forming an image of the fluidic chamber 10. The fluidic chamber 10 is advantageously fixed with respect to the image sensor 21, so as to limit variability. Thus, the particles P1, P2 set in motion in the fluidic chamber 10 are in motion with respect to the image sensor 21.

The surface of the image sensor 21 is advantageously oriented parallel to the two walls 11, 12 of the fluidic chamber 10, so as to be able to acquire a uniform image of the entire fluidic chamber 10. It will be seen below that the image sensor 21 is for example mounted directly under the component 1 containing the fluidic chamber, on a pivotable holder. It therefore follows the movement of the component 1.

It may for example be a question of a CCD image sensor or a CMOS image sensor.

The imaging device is said to be lensless because it comprises no image-forming optical system, and in particular no magnifying optics between the image sensor 21 and the fluidic chamber 10.

The advantage of this type of lensless device is that it allows wide-field imaging to be performed on microscopic objects, and therefore a high number of objects to be observed/detected, unlike a conventional microscope where the field is much smaller. The image acquired by the image sensor 21 comprises interference patterns (or diffraction patterns), each interference pattern being generated by one particle present in the liquid L contained in the fluidic chamber 10.

In one variant of embodiment, it is possible to employ a light source 20 capable of emitting at a plurality of different wavelengths, in order to obtain additional information on the samples.

It may also be combined with other detection systems or other modalities to obtain greater precision in respect of the observed objects in the case of complex samples possessing a number of families of particles of varying densities.

### Mechanical Device

### FIG. 1

One of the particularities of the invention is that the fluidic chamber 10 is able to be inclined with respect to the horizontal plane X, Y, so that its two opposite walls 11, 12 each make a non-zero angle A to said horizontal plane X, Y.

To this end, the system of the invention may comprise a mechanical device used to incline the fluidic chamber 10, to the selected angle A.

This mechanical device may comprise different wedges, each wedge enabling inclination to a given angle. Non-limitingly, the mechanical device may also comprise a holder 30 mounted on a hinge 31 and a jack mechanism 32 or equivalent, fastened to said holder 30 and controlled to lift said holder 30 and to make it pivot about the axis of the hinge 31 to the desired inclination. The jack may be controlled by the processing means UC or by any other means.

It will be noted that it is also possible to incline the fluidic chamber 10, accompanied by the image sensor 21.

Non-limitingly, the fluidic chamber 10 will be inclined at an angle A sufficient to observe a sizeable movement of the particles (by sizeable movement, what is meant is that the distance travelled by each particle corresponds to several times the size of the particle), though the movement is not so sizeable that particles captured in one image by the image sensor 21 do not feature in the next image. The choice of this angle A will notably depend on the density ratios between the liquid L and the particles, and on the viscosity of the employed liquid L.

### Processing Means

### FIG. 1

The processing means UC are configured to process the images acquired by the image sensor 21. The processing means UC comprise a microprocessor and storage means. The microprocessor is configured to execute a sequence comprising the instructions required to perform image-processing operations and compute the paths of the particles, with a view to making it possible to discriminate between them (see below). It may also be programmed to control the mechanical device with a view to controlling the inclination of the fluidic chamber 10.

### Principle Implemented

It has been observed that when a particle is placed in a liquid L, the particle being denser or less dense than the liquid, the particle will tend to move (in a direction dependent on its density and on the density of the liquid) along the axis of inclination of the fluidic chamber 10.

Indeed, by applying the principle of dynamics to the particles during a movement at low speed through a viscous fluid, the fluid being assumed to be homogeneous and isotropic, and in the absence of movement of the fluid (friction assumed constant), it is possible to obtain the equations governing the acceleration and speed of a particle projected along the axis of inclination of the fluidic chamber:

$$v ( t ) = \frac{1}{v} \cdot g \cdot sin ( α ) \cdot V \cdot ( {ρ}_{particle} - {ρ}_{fluid} ) ( {e}^{\frac{v}{m} t} - 1 )$$

$$\frac{d}{dt} v ( t ) = \frac{L V}{m} sin ( α ) \cdot ( {ρ}_{particle} - {ρ}_{fluid} ) \cdot {e}^{\frac{v}{m} t}$$

with:
v: the coefficient of friction between the particle and the surrounding fluid;
V: the volume of the particle;
g: the acceleration due to gravity;
α: the angle of inclination of the device (which corresponds to the angle A defined above);
m: the mass of the particle;
ρ: the densities.

It may thus be seen that, depending on whether a particle is denser or less dense than the surrounding fluid, it will move in one direction or the other, the projection of the acceleration onto the axis of inclination being of the same sign as (ρ_{particle}−ρ_{fluid}).

In other words, by inclining the fluidic chamber 10 with respect to the horizontal by a non-zero angle A, if the first particles P1 and the second particles P2 have different densities, with the density of the first particles P1 higher than the density of the liquid L and the density of the second particles P2 lower than the density of the liquid L, the denser first particles P1 will tend to move in the natural direction corresponding to the inclination of the fluidic chamber 10, in a direction parallel to the axis of inclination of the chamber, and the less dense second particles will tend to move in the opposite direction to the direction corresponding to the inclination of the fluidic chamber 10, in a direction parallel to the axis of inclination of the fluidic chamber 10.

It will be noted that if the first particles P1 and second particles P2 are both denser or less dense than the surrounding liquid L, they will move in the same direction but at different relative speeds.

### Detection Method

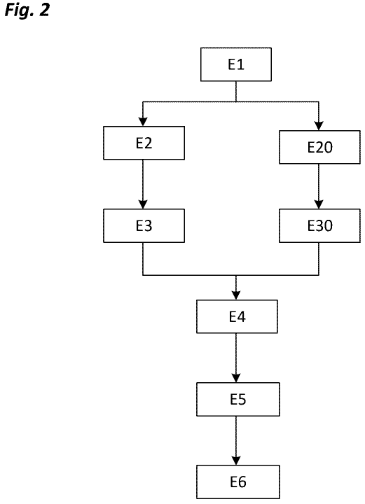

### FIG. 2

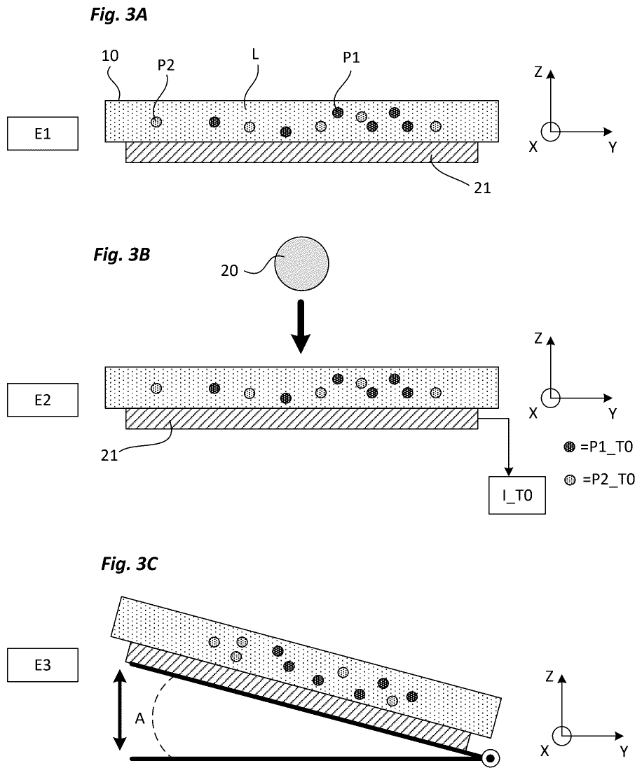

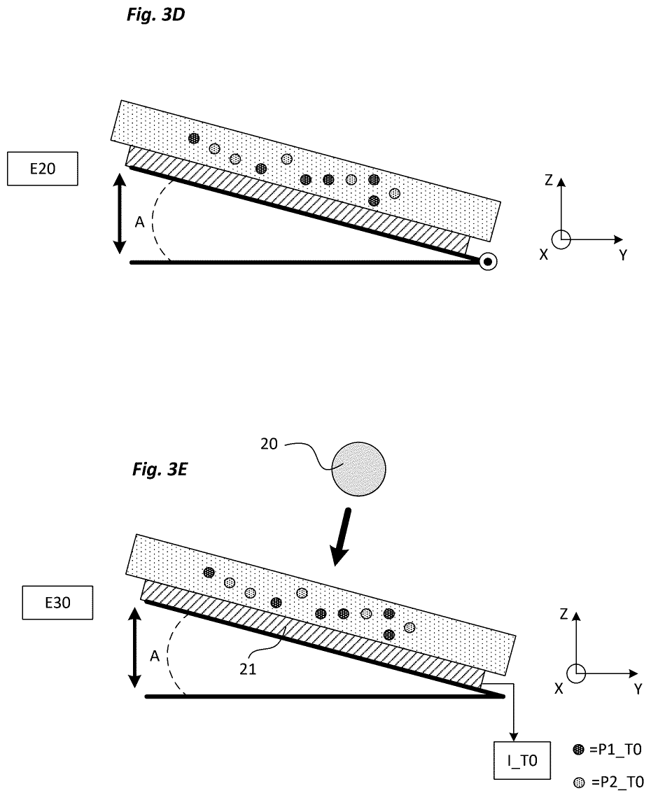

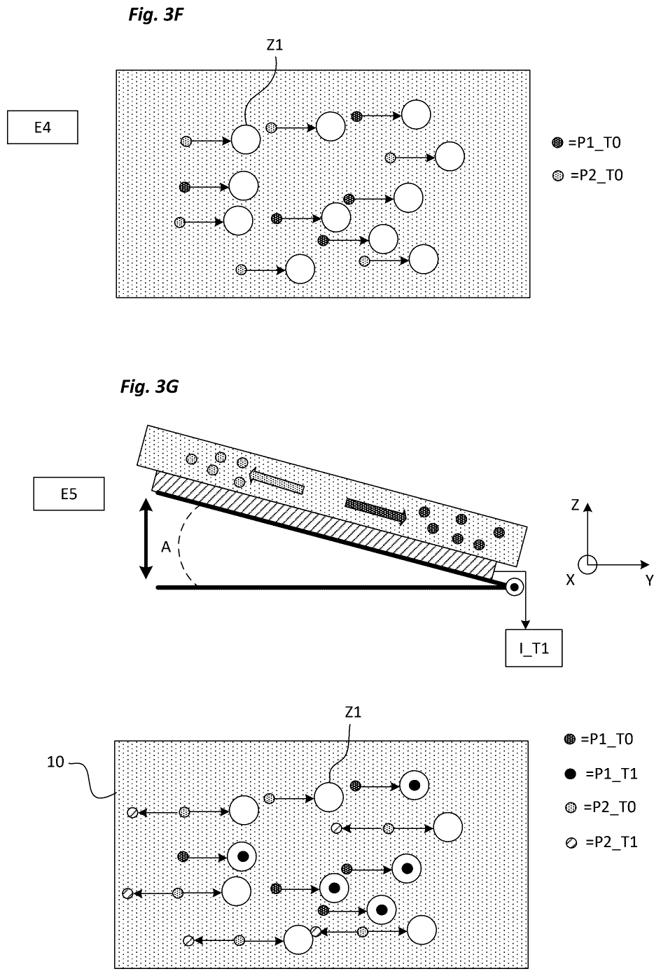

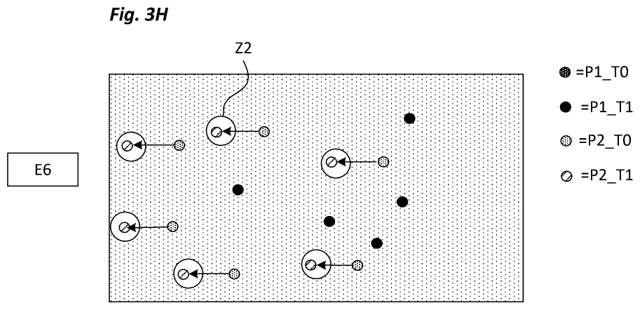

### FIGS. 3A to 3H.

The method consists in discriminating between the particles P1, P2 present in the liquid L placed in the fluidic chamber 10. In this description, the first particles P1 are considered to have a density higher than the density of the liquid L in which they are placed and the second particles P2 are considered to have a density lower than the density of the liquid L in which they are placed.

It comprises the following steps, described below:

E1—FIG. 3A: The fluidic chamber 10 is filled, via the fluidic inlet 13, with the liquid L containing the particles (first particles and second particles), until its volume is entirely occupied by the liquid L.

Two variants are then possible.

### First Variant:

E2—FIG. 3B: The processing means UC control the image sensor 21 to make a first acquisition at a first time TO, the fluidic chamber 10 being in the horizontal position. The first particles and second particles in a first position at T0 are referenced P1_T0 and P2_T0.

E3—FIG. 3C: The processing means UC control the mechanical device so as to incline the chamber to the desired angle A, which is non-zero with respect to the horizontal plane, to an angle of 30° for example. This inclination of the fluidic chamber 10 is intended to cause a movement of the particles, depending on their density with respect to the density of the liquid L.

### Second Variant:

E20—FIG. 3D: The processing means UC control the mechanical device so as to incline the fluidic chamber 10 to the desired angle A, which is non-zero with respect to the horizontal plane X, Y, to an angle A of 30° for example. This inclination of the fluidic chamber 10 causes a movement of the particles P1, P2, depending on their density with respect to the density of the liquid L.

E30—FIG. 3E: The processing means UC control the image sensor 21 to make a first acquisition at a first time TO, the fluidic chamber 10 being in the inclined position. The first particles and second particles in a first position at T0 are referenced P1_T0 and P2_T0.

Subsequently, the method is identical in both variants:

E4—FIG. 3F: The processing means UC are configured to estimate the position that each particle should have at a second time T1. The processing means UC thus determine an estimated position zone Z1, in which each particle should be located following a movement in the direction corresponding to the inclination of the fluidic chamber 10.

E5—FIG. 3G: The processing means UC control the image sensor 21 to make a second acquisition at the second time T1.

The processing means UC identify particles that are indeed located in their estimated position zone Z1. In the above example, the “denser” first particles P1 are indeed each located in their estimated position zone Z1, whereas the “less dense” second particles P2 are not in the estimated position zone Z1. Specifically, it may be seen that the first particles P1 then move in the direction corresponding to the inclination of the fluidic chamber 10, whereas the second particles P2, which are less dense than the liquid L, move in the opposite direction to that corresponding to the inclination of the fluidic chamber 10.

The processing means UC determine the path of the first particles P1 and may easily identify them with a view to sorting and counting them.

The first particles and the second particles in the position T1 are referenced P1_T1 and P2_T1.

E6—FIG. 3H: The processing means UC determine a second estimated position zone Z2 at the time T1 for the second particles P2, considering these second particles to be less dense than the liquid L. The second estimated position zone Z2 will be a zone to which each second particle P2 will have a tendency to rise.

Based on the image acquired at the second time T1, the processing means UC determine whether the second particles P2 are located in the second estimated position zone Z2.

The processing means UC identify particles that are indeed located in the second estimated position zone Z2. In the above example, the “less dense” second particles are indeed each located in the second estimated position zone Z2.

The processing means UC determine the path of the second particles and may easily identify them with a view to sorting and counting them.

Particles that are still isolated (not identified) after these two processing steps (E5 and E6) will either be particles the density of which differs greatly from the other two types of particles, and which thus may be the subject of a new step of predicting position, or need not be taken into consideration as it is likely they have not moved with respect to the sensor.

In a case where the second particles P2 have a density equivalent to that of the liquid L, the processing means UC are able to discriminate between them and the first particles P1, even if they do not migrate through the liquid L to their estimated position zone.

It will be noted that if a plurality of particles is located in the same estimated position zone, the processing means are for example configured to choose the particle that minimizes a distance, which is either purely spatial in the absence of a particle descriptor, or which takes into account various selected descriptive variables.

The process may of course continue after the time T1, with a view to reconstructing the path of each particle present in the liquid L.

It will be noted that when computing the estimated position zone for each particle, the processing means take into account the speed at which the particle should move through the fluid, an assumption being made as to the density of the targeted particle and/or their behaviour being observed during preliminary trials for example. Since the movement of the particles, which is related to application of an angle of inclination to the fluidic chamber, is deterministic, it is possible to define an average movement to be taken as reference.

If the particle is indeed located in its estimated position zone at the time T1, the processing means may conclude that it is indeed a question of the targeted particle to be counted.

It will also be noted that if the first particles P1 and second particles P2 are both denser or less dense than the surrounding liquid L, they will move in the same direction but at different speeds. The estimated position zone of the particle could be configured in light of an assumption as to the density of each type of particle and/or by performing preliminary trials.

A simple solution is thus obtained, allowing discrimination between particles within a liquid, using a simple mechanical device to tilt the fluidic chamber 10 and a lensless imaging device.

1. A method of detection of particles of a first type, called first particles (P1), present in a liquid (L), said liquid also containing particles of a second type distinct from the first type, and called second particles (P2), said liquid (L) being placed in a fluidic chamber, said first particles (P1) each having a density distinct from that of the liquid (L) and from that of each of the second particles (P2), said fluidic chamber having a closed volume occupied entirely by said liquid (L), said detection being achieved by capturing images of said fluidic chamber, wherein the method consists in:
capturing at a first time at least a first image of the fluidic chamber, said fluidic chamber being in a first position,
capturing at a second time, subsequent to the first time, at least a second image of the fluidic chamber in a second position, said second position being a position that is inclined with respect to a horizontal plane and that is configured to initiate at least one movement of the first particles (P1) inside the liquid,
processing said captured images to determine the movement and/or speed of the first particles (P1) present in the liquid (L),
discriminating between the first particles (P1) and second particles (P2) on the basis of the movement and/or speed of said first particles (P1) in the liquid, said movement and/or speed of said first particles (P1) and said second particles (P2) in the liquid depending on their respective density with respect to that of the liquid.

2. The method according to claim 1, wherein the first position is a position in which the fluidic chamber is oriented parallel to said horizontal plane.

3. The method according to claim 1, wherein the first position is a position that is inclined at a first angle of inclination with respect to said horizontal plane and in that the second position is a position making a second angle of inclination to the horizontal plane that is more pronounced than said first angle of inclination.

4. The method according to claim 3, wherein the first position and the second position are identical.

5. The method according to claim 1, wherein the method comprises:
a step of determining the position of the first particles (P1) and of the second particles (P2) at the first time (T0), and
a first step of estimating the position of the first particles (P1) and of the second particles (P2) at the second time (T1) and of determining, for each particle, a first estimated position zone (Z1) at the second time (T1).

6. The method according to claim 5, wherein the method comprises:
a step of verifying at the second time (T1) the position of the first particles (P1) and of the second particles (P2) with respect to their first estimated position zone (Z1), and
a step of determining the path of each particle detected at the second time (T1) in its first estimated position zone (Z1).

7. The method according to claim 5, wherein the method comprises a second step of estimating the position of the particles not detected in their first estimated position zone (Z1) and of determining a second estimated position zone (Z2) for these particles.

8. A detection system employed to implement the detection method such as defined in claim 1, wherein the detection comprises:
a fluidic chamber intended to be filled with the liquid containing the first particles and second particles,
a mechanical device that is able to be actuated to make the fluidic chamber or the entire device pivot to its second position,
an imaging device comprising at least one light source and an image sensor, said fluidic chamber being placed between said light source and the image sensor,
means for processing the images acquired by the sensor.

9. A system according to claim 8, wherein the fluidic chamber is formed in a component having two parallel walls that are transparent to one or more wavelengths of the light emitted by the light source.

10. The system according to claim 8, wherein the light source comprises one or more light-emitting diodes, or a laser diode.
